(19) United States
(12) Patent Application Publication
(10) Pub. No.: US 2023/0349014 A1
(43) Pub. Date: Nov. 2, 2023

(54) Blast furnace for ironmaking production

(71) Applicant: ArcelorMittal, Luxembourg (LU)

(72) Inventors: Dominique SERT, Montoy Flanville (FR); Edouard IZARD, Saint Julien Les Metz (FR)

(21) Appl. No.: 18/025,973

(22) PCT Filed: Sep. 15, 2020
(86) PCT No.: PCT/IB2020/058562

§ 371 Date: Mar. 13, 2023

(51) Int. Cl. C21B 7/06; C21B 13/00

(52) U.S. Cl. CPC C21B 7/06; C21B 13/0073

(57) ABSTRACT

A blast furnace for ironmaking production wherein iron ore is at least partly reduced by a reducing gas which is injected in the stack of the blast furnace in an injection zone, the blast furnace comprising an external wall and an internal wall in contact with matters charged into the blast furnace, wherein in the injection zone the internal wall comprises local inwards enlargements and the reducing gas injections are performed below said inwards enlargements.

The invention is related to a blast furnace for ironmaking production and to a process for the injection of a reducing gas into said blast furnace.

### BACKGROUND

In blast furnaces, the conversion of the iron-containing charge (sinter, pellets and iron ore) to cast iron, or hot metal, is conventionally carried out by reduction of the iron oxides by a reducing gas (in particular containing CO, H2 and N2), which is formed by combustion of coke at the tuyeres located in the bottom part of the blast furnace where air preheated to a temperature between 1000° C. and 1300° C., called hot blast, is injected.

In order to increase the productivity and reduce the costs, auxiliary fuels are also injected at the tuyeres, such as coal in pulverized form, fuel oil, natural gas or other fuels, combined with oxygen enrichment of the hot blast.

The gas recovered in the upper part of the blast furnace, called top gas, mainly consists of CO, CO2, H2 and N2 in respective proportions of 20-28% v, 17-25% v, 1-5% v and 48-55% v. Despite partial use of this gas as fuel in other plants, such as power plants, blast furnace remains a significant producer of CO2.

### SUMMARY OF THE INVENTION

In view of the considerable increase in the concentration of CO2 in the atmosphere since the beginning of the last century and the subsequent greenhouse effect, it is essential to reduce emissions of CO2 where it is produced in a large quantity, and therefore in particular at blast furnaces.

For this purpose, during the last 50 years, the consumption of reducing agents in the blast furnace has been reduced by half so that, at present, in blast furnaces of conventional configuration, the consumption of carbon has reached a low limit linked to the laws of thermodynamics.

One known way of additionally reducing CO2 emissions is to reintroduce top gases that are purified of CO2 and that are rich in CO into the blast furnace, said blast furnaces are known as TGRBF (Top-Gas Recycling Blast Furnaces). The use of CO-rich gas as a reducing agent thus makes it possible to reduce the coke consumption and therefore the CO2 emissions. This injection may be done at two levels, at the classical tuyere level, in replacement of hot blast and in the reduction zone of the blast furnace, for example in the lower part of the stack ok the blast furnace.

This so-called shaft injection of reducing gas must however not disturb the running of the ironmaking process and impair its productivity.

There is a need for a blast furnace having a reduced environmental impact with same or improved level of productivity than conventional blast furnace.

The present invention provides a blast furnace, wherein iron ore is at least partly reduced by a reducing gas which is injected in the stack of the blast furnace in an injection zone, said blast furnace comprising an external wall and an internal wall in contact with matters charged into the blast furnace, wherein in said injection zone the internal wall comprises local inwards enlargements and the reducing gas injections are performed below said inwards enlargements.

The blast furnace of the invention may also comprise the following optional characteristics considered separately or according to all possible technical combinations:
the enlargements have a width W comprised between 50 and 250 mm,
the reducing gas injections are performed in the vicinity below the enlargements,
the reducing gas injections are performed at a distance L below the enlargements which are inferior or equal to the width W of said enlargement,
the local enlargements are performed by adding a protrusion to the internal wall,
the internal wall is made of staves in contact with matters charged into the blast furnace and the local enlargements are made by using staves having a trapezoidal section,
the reducing gas is injected by an injection device able to inject the gas downwards,
the reducing gas is injected by an injection device able to inject the gas at an angle α with a plan X perpendicular to the blast furnace internal wall comprised between 15° and 30°,
the blast furnace has a working height H and the reducing gas injection is performed at a height comprised between 20% and 70% of said working height H, starting from the tuyere level,
the blast furnace has a working height H and the reducing gas injection is performed at a height which is comprised between 30% and 60% of said working height H, starting from the tuyere level.

The invention is also related to an ironmaking method preformed in a blast furnace according to the previous embodiments wherein the reducing gas injection is performed at a speed comprised between 75 m/s and 200 m/s.

The ironmaking method may also comprise the following optional characteristics considered separately or according to all possible technical combinations:
the reducing gas contains part of top gas exhausted from the blast furnace during the ironmaking process,
the reducing gas is injected at a temperature comprised between 850° C. and 1200° C.,
the reducing gas contains preferentially between 65% v and 75% v of carbon monoxide CO, between 8% v and 15% v of hydrogen H2, between 1% v and 5% v of carbon dioxide CO2, remainder being mainly nitrogen N2.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a side view of a blast furnace with reducing gas injection in the reduction zone

FIG. 2 illustrates an upper view of the blast furnace of FIG. 1

FIG. 3 illustrates a shaft furnace according to an embodiment of the invention

FIGS. 4A, 4B and 4C illustrate a DEM-CFD simulation of the inside of a shaft furnace according to the invention with variation of the reducing gas injection location

FIGS. 5A to 5E illustrate a DEM-CFD simulation of the inside of a shaft furnace according to the invention with variation of angle of reducing gas injection

### DETAILED DESCRIPTION

Elements in the figures are for illustration only and may not have been drawn to scale.

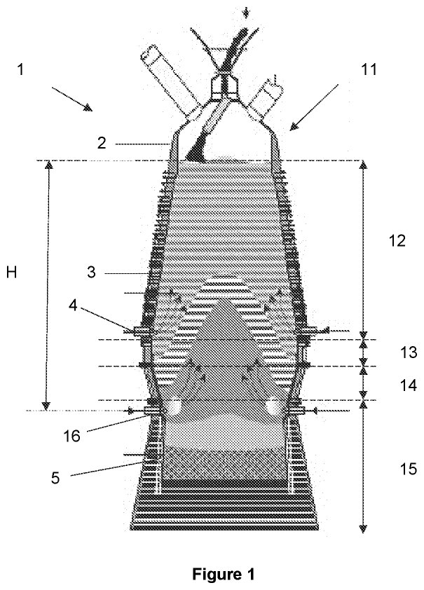

FIG. 1 is a side view of a blast furnace according to the invention. The blast furnace 1, comprises, starting from the top, a throat 11 wherein materials are loaded and gas exhaust, a stack (also called shaft) 12, a belly 13, a bosh 14 and a hearth 15. The materials loaded are mainly iron-bearing materials such as sinter, pellets or iron ore and carbon-bearing materials such as coke. The hot blast injection necessary to carbon combustion and thus iron reduction is performed by tuyeres 16 located between the bosh 14 and the hearth 15. In terms of structure, the blast furnace has an external wall, or shell 2, this shell 2 being covered, on the inside of the blast furnace, by a refractory lining and staves 3, as illustrated in FIG. 3, forming an internal wall 5. To reduce consumption of coke, which is the main carbon provider for iron reduction, it has been envisaged to inject a reducing gas in the blast furnace in addition to the hot blast. This reducing gas injection is performed in the stack of the blast furnace, preferentially in the lower part of the stack 12, for example just above the belly 13. In a preferred embodiment the reducing gas injection is performed at a distance from the classical tuyere level, comprised between 20% and 70%, preferentially between 30 and 60% of the working height H of the furnace. The working height H of a blast furnace is the distance between the level of injection of hot blast through classical tuyeres and the zero level of charging, as illustrated in FIG. 1.

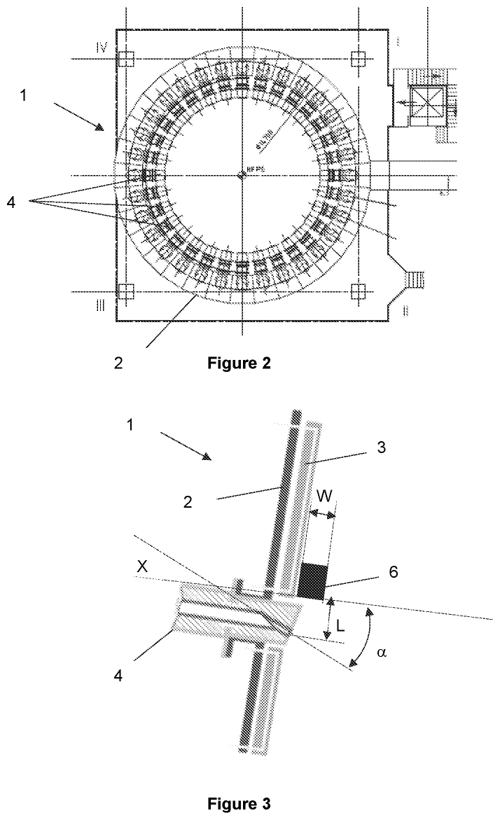

The injection is performed through several injection outlets 4 around the circumference of the furnace, as illustrated in FIG. 2, which is a top view of the blast furnace 1 at the level of injection of the reducing gas. In a preferred embodiment there are as many injection outlets as staves forming the internal wall 2. Between 200 and 700 Nm³ of reducing gas are injected per tons of hot metal in the blast furnace.

FIG. 3 illustrates an injection outlet 4 in a furnace according to an embodiment of the invention. In this embodiment the stave 3 is provided with a protuberance 6 which forms a local enlargement of the internal wall 2 and the injection outlet 4 is located below this local enlargement. The protuberance is one embodiment of a local enlargement but other ways of doing it may be considered, such as, for example implementation of a stave having a trapezoidal shape, such that the bottom of the stave is larger than its top and the injection outlet is located below said bottom. By local enlargement it is meant a local increase of the width of the internal wall. Doing the injection below the local enlargement allows to create a cavity, which is a zone with no material, which protects the injection area from movement of materials within the furnace and thus improve the durability of the injection device. It moreover avoids clogging of the injection device as not material comes close to the injection outlet. In a preferred embodiment this width W is comprised between 50 and 250 mm so as to provide a size of cavity sufficient for the injection outlet protection. The injection outlet is located at a distance L from the enlargement. In a preferred embodiment this distance L is closest to zero and preferentially inferior to the width W of the enlargement. As the width, this parameter allows to control the size of the cavity formed. The gas injection outlet 4 is designed so that reducing gas is ejected at an angle α, with a plan X perpendicular to the internal wall at the location of the enlargement. In a preferred embodiment angle α is comprised between 0 and 30°. This specific range allows to increase the depth at which the reducing gas penetrates in the furnace and thus to improve its contact with internal burden. Above 30°, a bigger quantity of gas is cooled by contact with the internal wall and won't provide the expected reduction effect.

When an ironmaking process is performed in a shaft furnace according to the invention, the reducing gas is preferably injected at a speed comprised between 75 and 200 m/s in order to have cavity size sufficient to protect the injection device. In the range 120-200 m/s the size cavity does not increase anymore and above 200 m/s the cavity is not controlled and may impair the good distribution of the burden due to the formation of mixed layers of coke and iron-bearing materials and thus the productivity of the ironmaking process.

In a preferred embodiment the reducing gas which is introduced into the blast furnace is top gas exhausted from said furnace which is subjected to gas treatment so as to remove dust and get appropriate composition, pressure and temperature. This reducing gas contains preferentially between 65% v and 75% v of carbon monoxide CO, between 8% v and 15% v of hydrogen H2, between 1% v and 5% v of carbon dioxide CO2, remainder being mainly nitrogen N2. It is preferentially injected at a temperature comprised between 850 and 1200° C.

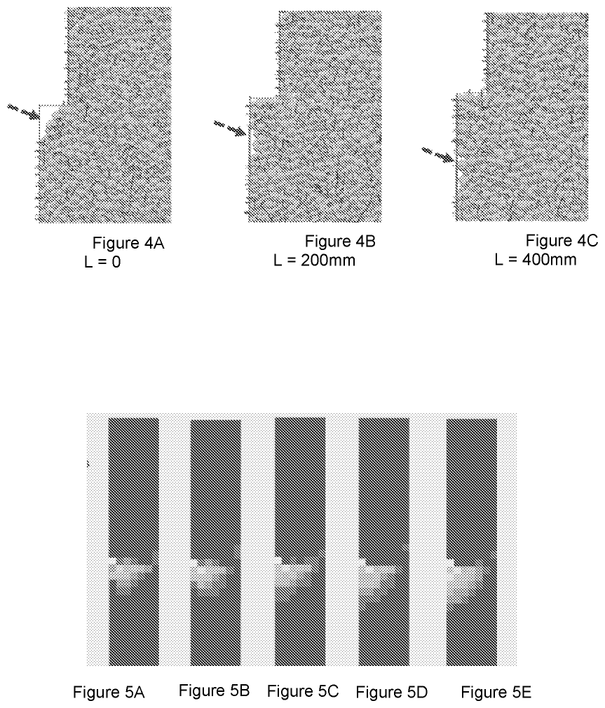

FIGS. 4A, 4B and 4C are the results a DEM-CFD (Discrete Element Method and Computational Fluid Dynamics) simulation of material movements inside a blast furnace according to the invention, depending on the reducing gas injection location in relation to the enlargement. In FIG. 4A the gas is injected in the vicinity of the local inwards enlargement, we can consider that distance L is equal to zero. In FIG. 4B distance L is equal to 200 mm and in FIG. 4C it is equal to 400 mm. In the simulation enlargement width is constant for all figures and equal to 200 mm reducing gas speed is constant too and equal to 120 m/s while the injection angle α was fixed to 30°. From the simulation one can observed that the farther we are from the enlargement, the smaller is the cavity. There is even no cavity creation at 400 mm. It is thus a preferred embodiment to have an injection located between 0 and 200 mm in this specific configuration.

FIGS. 5A to 5E are the results of a CFD simulation of the gas injected into a blast furnace according to the invention with variation of the angle α of injection. In FIGS. 5A, 5B, 5C, 5D, 5E angle α is respectively equal to 0°, 15°, 30°, 45°, 60°. In the simulation enlargement width is constant for all figures and equal to 200 mm, reducing gas speed is constant too and respectively equal to 120 m/s, while the injection was performed in the vicinity of the enlargement (L=0 mm). Reducing gas is represented by squares, the darker is the square, the higher is its quantity. From the simulation one can observed that starting with an angle of 15° more gas go deeper into the burden charged into the blast furnace. However, when the angle is higher than 30° gas tends to flow towards the internal wall of the furnace where it is cooled and will not go in contact with the burden.

With a blast furnace according to the invention it is thus possible to efficiently inject reducing gas and thus to limit the coke consumption and the CO2 emission without impairing the burden flowing into the furnace and decrease the productivity of the blast furnace.

What is claimed is:

1-14. (canceled)

15. A blast furnace for ironmaking production where iron ore is at least partly reduced by a reducing gas, the blast furnace comprising:
a stack, the reducing gas being injected in the stack in an injection zone;
an external wall; and
an internal wall in contact with matters charged into the blast furnace, the internal wall in the injection zone having local inward enlargements, the reducing gas injection locations being below the enlargements.

16. The blast furnace as recited in claim 15 wherein the enlargements have a width of between 50 and 250 mm.

17. The blast furnace as recited in claim 15 wherein the reducing gas injection locations are directly below the enlargements.

18. The blast furnace as recited in claim 15 wherein the reducing gas injection locations are at a distance L below the enlargement, the distance L being inferior or equal to a width of the enlargements.

19. The blast furnace as recited in claim 15 wherein the enlargements are protrusions added to the internal wall.

20. The blast furnace as recited in claim 15 wherein the internal wall is made of staves in contact with matters charged into the blast furnace and the enlargements are made by using staves having a trapezoidal section.

21. The blast furnace as recited in claim 15 wherein the reducing gas is injected by an injector designed to inject the reducing gas downwards.

22. The blast furnace as recited in claim 21 wherein the injector injects the reducing gas at an angle between 15° and 30° with respect to a plan perpendicular to the internal wall 5.

23. The blast furnace as recited in claim 15 wherein the blast furnace has a working height starting from a tuyere level and the reducing gas injection location is at a height between 20% and 70% of the working height.

24. The blast furnace as recited in claim 15 wherein the blast furnace has a working height starting from a tuyere level and the reducing gas injection location is at a height between 30% and 60% of the working height.

25. An ironmaking method performed in a blast furnace as recited in claim 15, wherein reducing gas injections are performed at a speed between 75 m/s and 200 m/s.

26. The ironmaking method as recited in claim 25 wherein the reducing gas contains part of top gas exhausted from the blast furnace during the ironmaking process.

27. The ironmaking method as recited in claim 25 wherein the reducing gas is injected at a temperature between 850° C. and 1200° C.

28. The ironmaking method as recited in claim 25 wherein the reducing gas has the following composition by volume:
65%≤CO≤75%
8%≤H₂≤15%
1%≤CO₂≤5%
remainder being N₂.
